(19) United States
(12) Patent Application Publication
(10) Pub. No.: US 2011/0188745 A1
(43) Pub. Date: Aug. 4, 2011

(54) IMAGE PROCESSING APPARATUS AND PROCESSING METHOD OF THE IMAGE PROCESSING APPARATUS

(75) Inventor: Seijiro Morita, Kawasaki-shi (JP)

(73) Assignee: CANON KABUSHIKI KAISHA, Tokyo (JP)

(21) Appl. No.: 12/987,282

(22) Filed: Jan. 10, 2011

(30) Foreign Application Priority Data
Feb. 2, 2010 (JP) 2010-021587

(51) Int. Cl. G06K 9/46; G06K 9/00

(52) U.S. Cl. 382/165; 382/195

(57) ABSTRACT

A table structure in a specific area of a document is analyzed, and cells included in a table are determined as a processing unit to generate processing instruction information for instructing a process for the determined processing unit.

### BACKGROUND OF THE INVENTION

1. Field of the Invention

The present invention relates to an image processing apparatus and a processing method.

2. Description of the Related Art

Conventionally, there is a technique of using a computer to analyze an image on paper read by a scanner to recognize characters, etc. written on the paper. The use of the technique allows easily extracting the amount of money, date, etc. written on, for example, a multiplicity of business forms and inputting the extracted data into a process of compilation, etc. However, what kind of data is on which position of the paper needs to be instructed for the computer to automate the process.

First, an answer sheet to be processed and a processing instruction list describing entry fields to be processed in the answer sheet form and processing instruction information for instructing processes for the written contents in the entry fields are read out in a series of reading processes. There is a technique for detecting the processing instruction information from the data of the read out processing instruction list and recognizing writing areas to be processed on the paper based on the analysis and the processing contents of the writing areas (for example, Japanese Patent Laid-Open No. 2008-145611).

However, in the conventional technique, the processes are applied to the areas that are to be processed written by the user in the processing instruction list. Therefore, more complicated instructions, such as an instruction for checking whether all of a plurality of areas are filled and an instruction for not outputting the result if not all of the plurality of areas are filled, cannot be issued. For example, in a form with a table, the user cannot use the processing instruction list to issue an instruction for checking whether all rows in the table are filled and not checking the rows that are not used at all. Therefore, the convenience of the user is significantly lost.

### SUMMARY OF THE INVENTION

The present invention provides an apparatus and a method capable to more easily instruct a process for a cell in a table in a specific area of a document.

An aspect of the present invention provides an image processing apparatus that generates processing instruction information for instructing a process for a specific area of a document, the apparatus comprising: a determination unit that analyzes a table structure in the specific area of the document to determine a plurality of cells included in a table as a processing unit; and a generation unit that generates the processing instruction information for instructing a process for the processing unit determined by the determination unit.

Further features of the present invention will become apparent from the following description of exemplary embodiments (with reference to the attached drawings).

### BRIEF DESCRIPTION OF THE DRAWINGS

FIG. 1 is a block diagram showing a configuration of an image processing apparatus as an example of the present embodiments.

FIG. 2A is a diagram showing an example of a form of a document used in a first embodiment, FIG. 2B is a diagram showing an example in which the user has used a color pen to add arbitrary areas for checking among the items included in the document of FIG. 2A, and FIG. 2C is a diagram showing an example of a document to be checked.

FIGS. 3A and 3B are flow charts showing a scan ticket creation process in a first embodiment.

FIG. 4 is a diagram showing an example of a result of table analysis of a user-designated area 33 shown in FIG. 2B in S520.

FIG. 5 is a flow chart showing a processing unit determination process.

FIG. 6 is a diagram showing an example of a table used in a process of determining a processing unit.

FIG. 7 is a diagram showing an example of processing instruction information 901.

FIG. 8 is a diagram showing an example of a detail setting operation screen of processing content for the user-designated area 33.

FIG. 9 is a diagram showing an example of a selection range setting screen.

FIG. 10 is a diagram showing an example of a process setting screen.

FIG. 11 is a flow chart showing a document checking process by use of a scan ticket.

FIG. 12 is a diagram showing an example of output of a check result.

FIG. 13A is a diagram showing an example of a form of a document used in a second embodiment, FIG. 13B is a diagram showing an example of a processing instruction list, and FIG. 13C is a diagram showing an example of a document to be checked.

FIG. 14 is a flow chart showing a processing unit determination process in the second embodiment.

FIG. 15 is a diagram showing an example of a processing instruction list used in a third embodiment.

FIG. 16 is a flow chart showing an instruction content analysis process in the third embodiment.

### DESCRIPTION OF THE EMBODIMENTS

Hereinafter, embodiments of the invention will be described in detail with reference to the drawings. Although a multi-function device with a plurality of functions, such as a copy function and a scanner function, will be described as an example of an image processing apparatus in the following description, a plurality of apparatuses with the functions may be interlinked to realize the image processing apparatus.

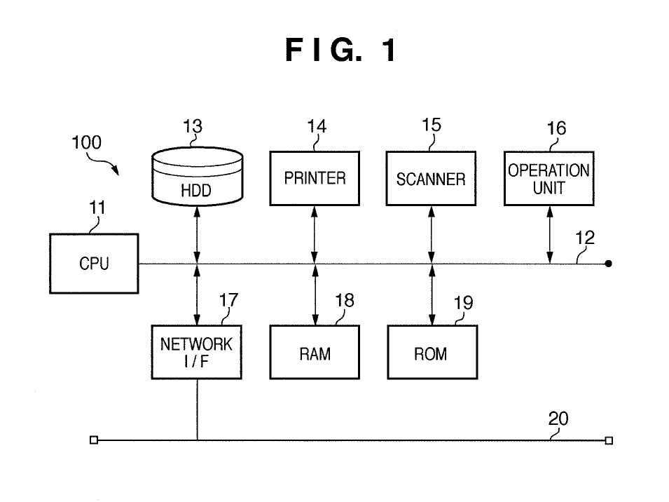

FIG. 1 is a block diagram showing a configuration of the image processing apparatus as an example of the embodiments. A CPU 11 loads programs stored in a ROM 19 onto a RAM 18 to control the entire operations of an image processing apparatus 100. The CPU 11 also communicates with other configurations in the image processing apparatus 100 through a bus 12. An HDD 13 is a hard disk drive including a hard disk, and the HDD 13 stores image data inputted from the outside, image data read out by a scanner 15, various information, etc. A printer 14 includes a printer engine of an electrophotographic type, an inject type, etc. and prints an image on recording paper (sheet) based on the image data applied with various image processes.

The scanner 15 reads an image on a document set by the user on a copy board as a color image and stores obtained electronic data (image data) in the HDD 13 or the RAM 18. The scanner 15 includes a document feeding apparatus, and the scanner can sequentially feed a plurality of documents set on the document feeding apparatus to the copy board and read the documents. An operation unit 16 includes a display unit that displays a plurality of keys for the user to issue instructions to the image processing apparatus 100 and various pieces of information for the user. A network I/F 17 connects the image processing apparatus 100 to a network 20 and controls the reception of data from external apparatuses on the network 20 and the transmission of data to the external apparatuses on the network.

Although an example in which the image data to be processed is inputted through the scanner 15 will be described, image data of a document transmitted from an external device on the network 20 through the network I/F 17 may be inputted. Although the image processing apparatus 100 will be described, a personal computer (PC), etc. connected to the scanner 15 and the printer 14 can also execute the same processes. In that case, all or part of the programs used in the present embodiments can be provided to the PC through a network, etc. or may be provided to the PC by storing the programs in an external storage medium, such as a CD-ROM.

### First Embodiment

A process in the image processing apparatus 100 to create a scan ticket for checking description items of a document and checking the scanned document will be described.

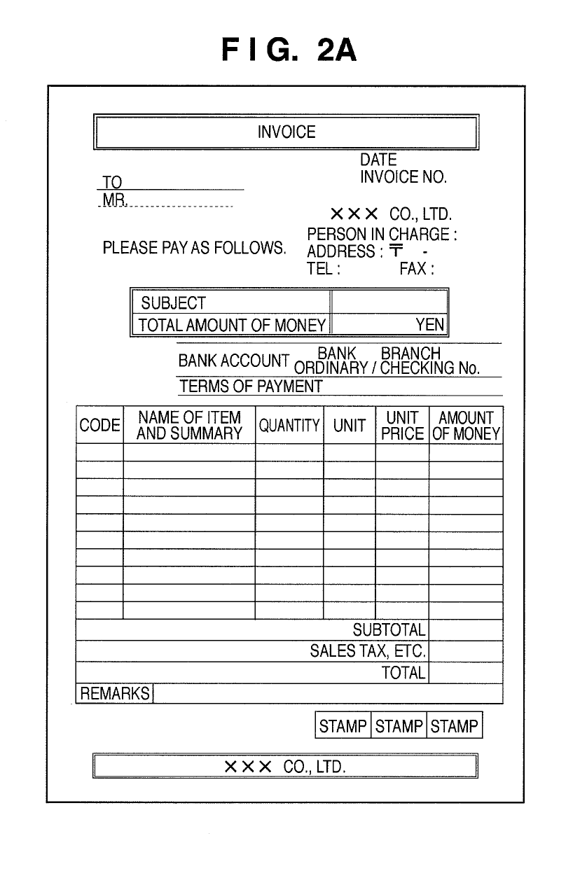

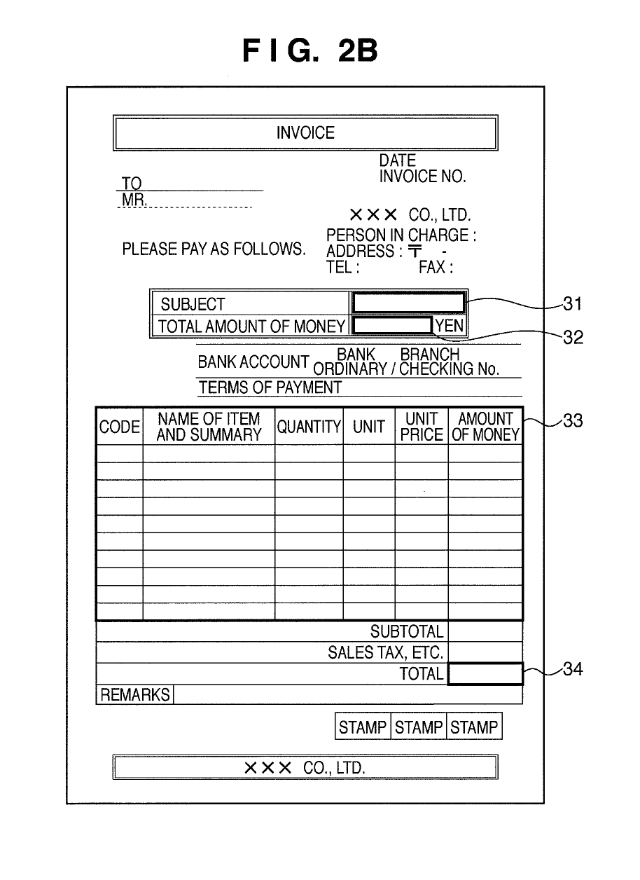

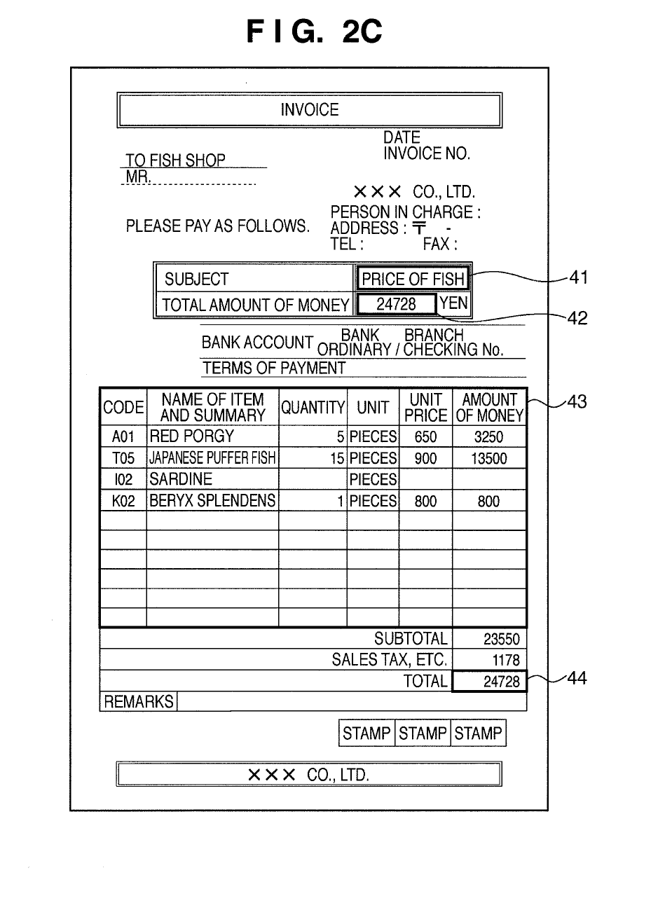

FIG. 2A is a diagram showing an example of a form of a document used in a first embodiment. The document is an invoice in which the user has not written anything (before addition of a processing instruction described below). The invoice includes company name of counterpart, person in charge of counterpart, subject, total amount of money, name of item, quantity, unit, unit price, amount of money, bank account information, subtotal, tax such as sales tax, remarks, area for stamp of publisher, etc. Fields for the user to add information upon the formal publishing of the invoice include subject, name of item, quantity, unit, unit price, amount of money, stamp of creator. In the first embodiment, whether information is added to a certain field designated by the user among the fields of the invoice is checked.

FIG. 2B is a diagram showing an example in which the user has used a color pen to add arbitrary areas for checking among the items included in the document of FIG. 2A. The document shown in FIG. 2B serves as the processing instruction list.

The user who checks the created invoice writes processing instruction information described below on paper in the same format as the invoice to be checked to create the processing instruction list. Therefore, the processing instruction list is a list in which the processing instruction information is written in the invoice shown in FIG. 2A. In the first embodiment, the user surrounds an area as a closed area, such as a rectangle, by a color pen, etc. to designate the area to be processed.

The processing instruction information (additional information) written in the invoice (document) will be described. In FIG. 2B, for example, areas 31 to 34 are areas written with a red pen. Colors other than the colors illustrated here can be used. The color is not limited to one color, and the color types may be increased or decreased according to the check content. Although a pen is used here, a substance other than the pen can be used as long as coloring is possible.

The user associates the information of the color of the processing instruction information to be used with the processing content in advance and uses the operation unit 16 to register the information and the content in the RAM 18. More specifically, the user registers in the RAM 18 that the description of information will be checked for the red color. The CPU 11 determines the color components (for example, hue) of the colors registered here and stores the content in the RAM 18.

Instead of registering the colors by use of the operation unit 16, the scanner 15 may read and register the content written on the paper. Instead of the registration by the user, the content may be registered in advance in the image processing apparatus 100. When the content registered in advance is followed, the user adds the processing instruction information to the document according to the registered colors and processing content.

In this way, the color components of the processing instruction information to be used and the processing content corresponding to the color components are registered to create the processing instruction list according to the registered content. The processing instruction list is used to extract the processing instruction information, and the processing content is recognized according to the extracted result. In this way, the image processing apparatus 100 checks whether there is information in specific areas of the document to be checked.

FIG. 2C is a diagram showing an example of the document to be checked. It is assumed that the document to be checked is based on a document in the same format as in FIGS. 2A and 2B. In the first embodiment, added processing instruction information is extracted as shown in FIG. 2B, and in accordance with the extraction result, the CPU 11 determines that the document is normal if areas 41 to 44 are filled and all fields in each row of the area 43 are filled. FIG. 2C shows an example in which conditions for determining that the document is normal are not satisfied, and the check result of the document is not normal (NG). The check result of the document satisfying all conditions for determining that the document is normal is normal (OK). The checked contents and areas are not limited to these, and instructions for other check contents and other areas are also possible.

A process of creating a scan ticket for checking the written content of the document based on the processing instruction list as shown in FIG. 2B will be described. The scan ticket is a ticket in a format (such as QR code) that allows the image processing apparatus 100 to recognize the instruction content shown in FIG. 2B and recognize the checking method of the document to be checked as shown in FIG. 2C.

The scan ticket includes instruction content recognized from the processing instruction list shown in FIG. 2B, position information of the areas for applying the instruction content, etc. To check the document to be checked, the scanner 15 reads the scan ticket, and the CPU 11 recognizes the processing content to check the document to be checked.

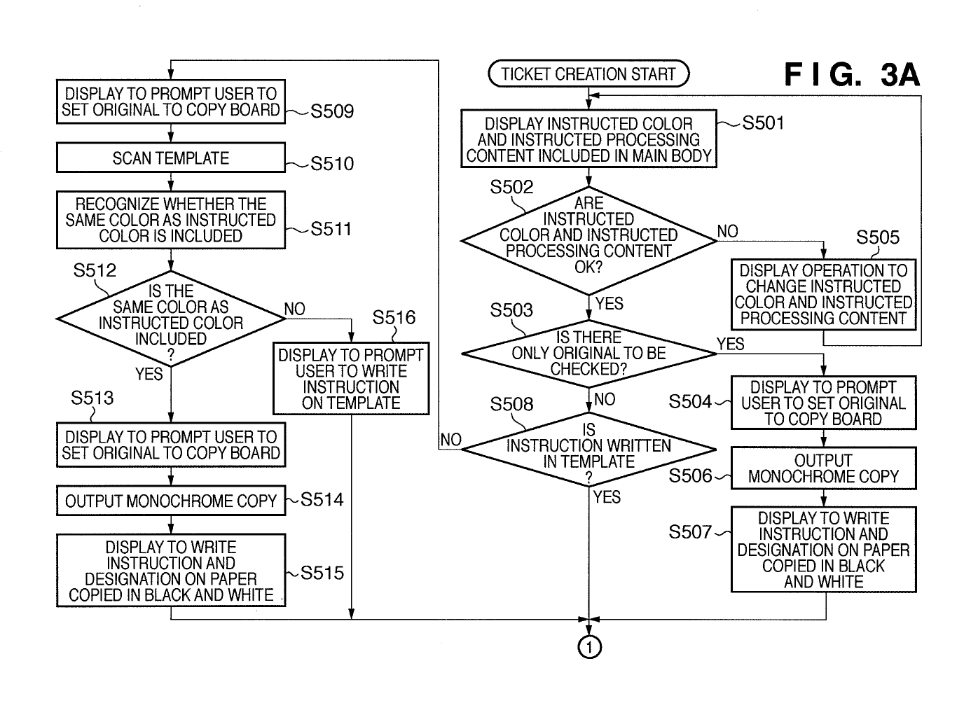

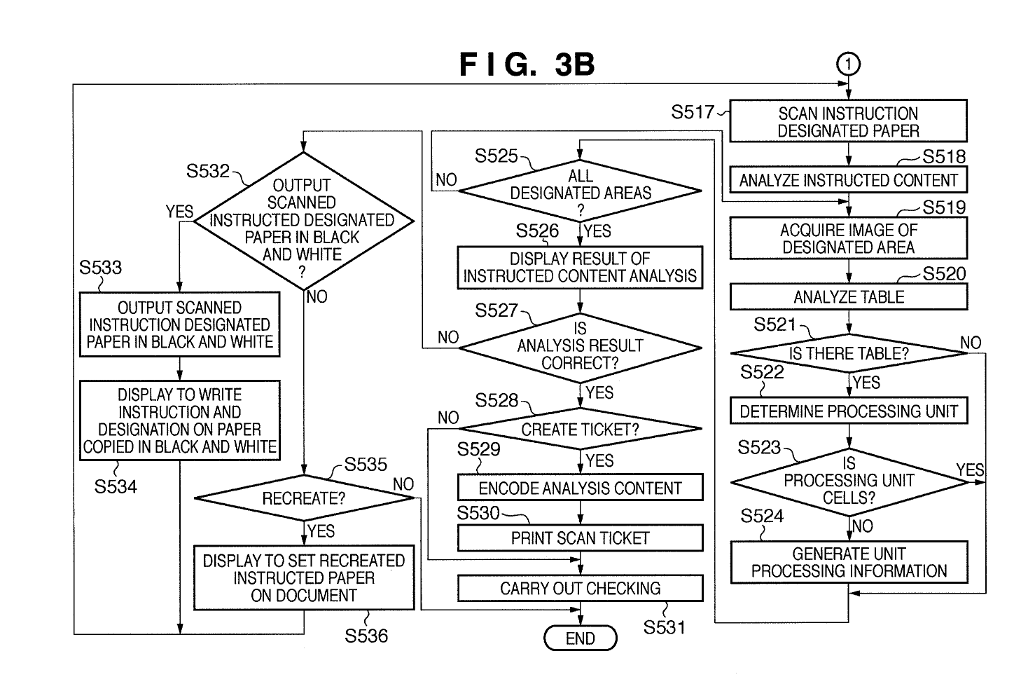

The process for creating the scan ticket will be described in detail. FIGS. 3A and 3B are a flow chart showing a scan ticket creation process in the first embodiment. The flow chart shows a flow of a process by the CPU 11 to load a program stored in the ROM 19 to the RAM 18 to execute the program.

When the user instructs creation of the scan ticket through the operation unit 16, the CPU 11 starts the process and displays a combination of the instructed color (hereinafter, simply called “instructed color”) and processing content of the processing instruction information registered in the RAM 18 to the display unit of the operation unit 16 (S501). For example, the CPU 11 displays “OK if areas surrounded by red color are filled”. The CPU 11 displays on the display unit a message for inquiring the user whether the instructed color and the processing content displayed in S501 can be confirmed (S502). If the user issues an instruction'of denial through the operation unit 16 in response to the inquiry, the CPU 11 displays on the display unit a message for changing the combination of the instructed color and the processing content (S505).

A new color may be presented in place of the instructed color after displaying an inquiry for changing a color, or the user may designate an arbitrary color from the operation unit 16. Instead of adopting a new color, just the combinations of the colors and the processing contents may be changed. Since a single color cannot instruct different processing contents, the CPU 11 performs control to set one processing content for one color.

If a changing process of the instructed color or the processing content, or if a changing process of both the instructed color and the processing content is executed in S505, the CPU 11 returns to S501. The execution of the changing process in S505 is displayed for the user to check. If the user issues an instruction of affirmation from the operation unit 16 in response to the inquiry of S502, the CPU 11 determines the instructed color of the processing instruction information to be used and the processing content corresponding to the color and registers the color and the content in the RAM 18.

The determination in S502 is designed to prevent an extraction error of the processing instruction information by making the user check the content of the document (colors included in the document) by visual observation and differentiating the color components if the color components of the instructed color and the color components included in the document are determined to be similar.

If the color components included in the document and the color components of the instructed color are determined to be similar as a result of the check in S502, monochrome copying of the document may be performed as described below. In that case, the CPU 11 displays a message prompting the user to set the document on the display unit of the operation unit 16 and performs the monochrome copying if the CPU 11 determines that the user has set the document. This can prevent the extraction error of the processing instruction information when the processing instruction information is added by a chromatic color pen. The determination according to the check result of the user can reduce the number of times the scanner needs to read the document.

If the CPU 11 determines that the instructed color and the processing content are OK in S502, the CPU 11 specifies the color components used for the processing instruction information and stores the color components in the RAM 18. The CPU 11 then displays a message for inquiring whether the user only has the check target document (FIG. 2C) on the display unit of the operation unit 16 (S503). This is a process of checking whether there is a document as a template (FIG. 2A or 2B) when the processing instruction list is created. The process allows creating a document for writing the processing instruction information from the check target document as described below if the user only has the check target document. The template denotes a document that allows the user to write and add the processing instruction information, not the formal check target document.

A response indicating that there is only the check target document (there is no document as a template) is received from the operation unit 16 in S503, the CPU 11 displays a message prompting the user to set the check target document to the scanner 15 on the display unit in S504. In this case, a guidance “Set a check target document to the scanner. Press OK button after setting.” and an OK button for recognizing the setting of the document are displayed.

Although the CPU 11 recognizes the setting of the document by the press of the OK button, a photo interrupter arranged below the copy board, a document sensor of the document feeding apparatus, etc. may be used to automatically recognize that the document is set to the scanner 15.

When the CPU 11 determines that the OK button is pressed in S504, the CPU 11 controls the scanner 15 to read the image on the document to be checked in S506. The CPU 11 then converts the image data inputted from the scanner 15 into monochrome image data and outputs the data to the printer 14 for monochrome copying to the recording paper.

Although the document is printed by the printer 14 in black and white in S506, the arrangement is not limited to this. The colors of the image of the read document can be converted to other colors not including the instructed color before printing by the printer 14. For example, the color is converted before outputting the document, such as by converting blue characters in the read document to red characters before outputting the document. Alternatively, a color to be converted may be registered in advance in the RAM 18, and the color may be converted if the same color as the registered color is in the read document.

In S507, the CPU 11 displays on the display unit a message prompting the user to write the processing instruction information as shown in FIG. 2B on the recording paper outputted by the printer 14 in S506.

If there is a response of the existence of the template document in S503, a message for inquiring whether the processing instruction information is already written in the template (FIG. 2B) is displayed on the operation unit 16 in S508. If a response from the user indicating that the instruction information is not written in the template is received from the operation unit 16 in response to the display, the CPU 11 displays on the display unit a message prompting the user to set the template to the scanner 15 in S509. For example, a guidance “Set the template to the scanner. Press OK button after setting.” and an OK button are displayed. Although the CPU 11 recognizes the setting of the document by the press of the OK button, the photo interrupter arranged below the copy board, the document sensor of the document feeding apparatus, etc. may be used to automatically recognize that the document is set to the scanner 15.

If the OK button is pressed in S509, the CPU 11 causes the scanner 15 to read the image on the document of the template in S510. In the following S511, the CPU 11 executes an analysis/recognition process for determining whether the read image data includes the color with the same color components as the instructed color. In the analysis/recognition process of the color components, for example, red hue is extracted to analyze and recognize whether the red color is included. Various known methods can be implemented for the analysis/recognition process of the color components. Parameters other than the hue may be used, and other parameters may be combined.

In S512, the CPU 11 determines whether the color analyzed and recognized in S511 includes the same color as the instructed color registered in the RAM 18. Not only the complete matching, but colors within a certain range may be determined to be the same. For example, if RGB values are indicated by 256 levels, the RGB values can be compared with the RGB values of the instructor color, and the values can be determined to be the same if the difference is within 20 levels. Methods other than the methods shown here can be applied to determine the same color.

If it is determined in S512 that the same color as the instructed color registered in RAM 18 is included in the image of the template, the CPU 11 displays on the display unit a message prompting the user to set the template to the scanner 15 in S513. For example, a guidance “Set the template to the scanner. Press OK button after setting.” and an OK button are displayed. The CPU 11 recognizes the setting of the document by the press of the OK button. However, the photo interrupter arranged below the copy board, the document sensor of the document feeding apparatus, etc. may be used to automatically recognize that the document is set to the scanner 15.

If the OK button is pressed in S513, the CPU 11 causes the scanner 15 to read the image on the document to be checked in S514. The CPU 11 then converts the image data inputted from the scanner 15 to monochrome image data and outputs the data to the printer 14 for monochrome copying to the recording paper.

Although the document is printed by the printer 14 in black and white in S514, the arrangement is not limited to this. The process can be replaced by various methods as in S506.

In S515, the CPU 11 displays on the display unit a message prompting the user to write the processing instruction information as shown in FIG. 2B on the recording paper outputted by the printer 14 in S514.

If the CPU 11 determines that the same color as the instructed color registered in the RAM 18 is not included in the image of the template in S512, the process proceeds to S516. In S516, the CPU 11 displays on the display unit a message prompting the user to write the processing instruction information as shown in FIG. 2B to the template document.

If the processing instruction information is already written in the template in S508, the scanner 15 reads the image of the document of the instruction-filled template in S517. In this case, the scanner 15 reads the document in the same procedure as in the monochrome copy output. More specifically, a message prompting the user to set the instruction-information-filled document to the operation unit 16 is displayed on the display unit, and when the user presses the OK button after setting the document, the scanner 15 reads the document. However, the image data read by the scanner 15 is not converted to the monochrome image data. The image data obtained here is stored in the RAM 18.

In S518, the processing instruction information is analyzed and recognized from the image data inputted from the scanner 15. Where in the document is the instructed color determined in S502 is first analyzed, and the colors of the part are recognized to specify the positions of the target areas of each color. The positions specified here allow determining the positions on the document and the sizes of the user-designated areas. For example, the area 31, i.e. the area written by the user with a red pen, is recognized as a red closed area in S518, and instruction content information including an upper left “start coordinate” and a lower right “end coordinate” indicated by the relative coordinate from the start coordinate can be extracted. When the position of the X-Y coordinate is expressed by (X, Y) for the end coordinate indicated by the relative coordinate from the start coordinate, X is synonymous with the main scan width, and Y is synonymous with the sub scan width. The CPU 11 associates and stores the position specified here and the processing content determined in S502 in the RAM 18.

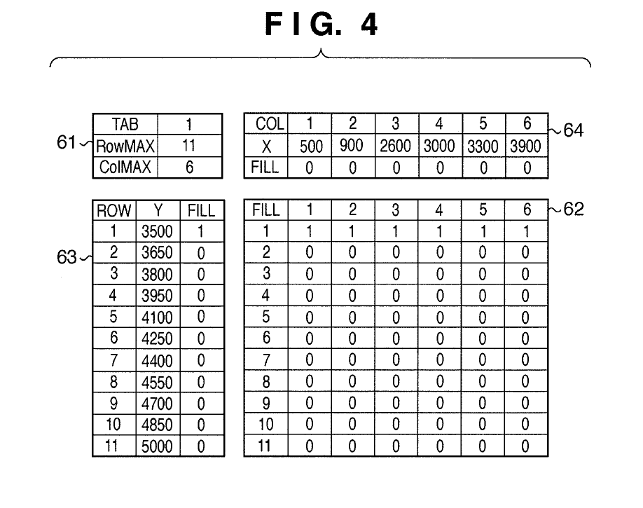

In S519, the CPU 11 uses the start coordinate and the end coordinate of the processing instruction information recognized in S518 to sequentially acquire the image data of the user-designated areas from the RAM 18. In S520, the CPU 11 performs the table analysis for the image data acquired in S519. FIG. 4 is a diagram showing an example of the result of the table analysis of the user-designated area 33 shown in FIG. 2B in S520. The example includes tables 61, 62, 63, and 64. In the table analysis process of the first embodiment, the table structures are analyzed, and whether the cells in the analyzed table are filled is determined. In the analysis of the table structure, the CPU 11 extracts all ruled lines from the image data acquired in S519, recognizes closed spaces separated by the ruled lines as cells, and recognizes an object constituted by a set of the cells as a table.

The table 61 indicates that it is recognized that a table (TAB=1) includes 6 cells in the column direction (ColMAX=6) and 11 cells in the row direction (RowMAX=11) as a result of the table analysis of the user-designated area 33 in S520. In the determination of whether the cells in the analyzed table are filled, the image data in the cell recognized by the analysis of the table structure is converted into an HLS color space, and whether the cells are filled is determined by the proportion of pixels in the cells with luminance L darker than predetermined brightness. In the first embodiment, the image data in the cells acquired from the image data is an RGB color space. Therefore, the proportion of the pixels in the cells in which the value of the luminance L is 50% or less is calculated, and the cells are determined to be filled if the proportion is 10% or more.

The method of determination is not limited to this as long as whether the cells are filled can be determined. For example, whether the cells are filled can be determined by the length that the dark pixels continue in the main scanning direction. The conversion from the RGB color space to the HLS color space used here is a known technique, and the details will not be described.

The table 62 indicates whether the cells are filled. The table 62 stores 1 for the cells that are filled (FILL=1) and stores 0 for the cells that are not filled (FILL=0). For example, when the position of the row-column of the cell is expressed by (row, column) in the user-designated area 33, it is recognized that “CODE” is written in the area equivalent to the cell (1, 1) of the table 62, and 1 is stored as the described information (FILL). The table 63 indicates Y coordinates of the start positions of the rows and whether all cells in each row are filled (FILL=1). The table 64 indicates X coordinates of the start positions of the columns and whether all cells in each column are filled (FILL=1).

In S521, the CPU 11 determines the result of analysis in S520. The process proceeds to S525 if there is no table in the image data and proceeds to S522 if there is a table. In S522, the result of analysis in S520 is used to determine the processing unit for outputting the check result.

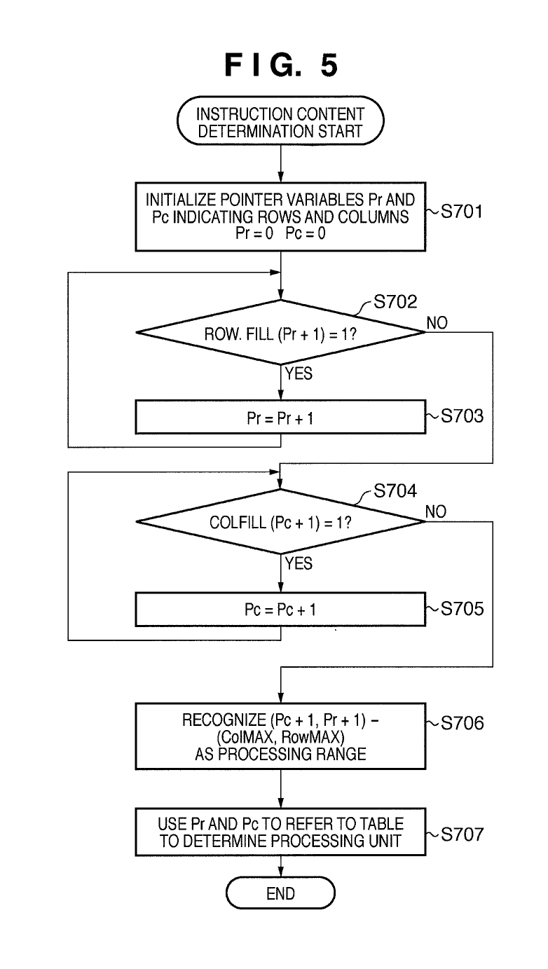

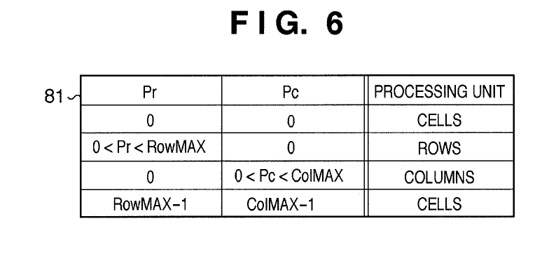

FIG. 5 is an example of a flow chart showing a processing unit determination process. FIG. 6 is an example of a table used in the process of determining the processing unit described below. The table is stored in the RAM 18. In S701, the CPU 11 first initializes local pointer variables Pr and Pc indicating rows/columns. In step S702, the CPU 11 refers to the table 62 of FIG. 4 to check whether all cells of each row are filled. The process proceeds to S703 if all cells of each row are filled, and the pointer Pr is advanced by one. The process proceeds to S704 in other cases.

The process of S702 and S703 allows checking to which row from the first row in the table all cells included in the row are filled. For example, if Pr=1 when the process has advanced to S704, all cells up to the first row are filled.

Similarly, up to which column from the first column in the table all cells included in the column are filled is checked in S704 and S705. In S706, the processing range is recognized. The CPU 11 uses the pointer variables Pr and Pc determined in S702 to S705 and RowMAX and ColMAX indicating the numbers of cells in the rows/columns to recognize the range indicated by the cell (Pr+1, Pc+1) to the cell (RowMAX, ColMAX) as the processing range. In S707, the processing unit is determined. The CPU 11 uses a table 81 shown in FIG. 6 and the pointer variables Pr and Pc to determine by which of the cells, rows, and columns the processing unit will be handled.

Tables often include items at the first row and the first column to allow the person who fills in the document to recognize what to write in the fields. For example, in the case of the user-designated area 33, all cells of only the first row are filled (FILL=1), and the cells of the first row are constituted by “CODE”, “Name of Item and Summary”, “Quantity”, “Unit”, “Unit Price”, and “Amount of Money”, respectively. The cells other than the first row are all blank (FILL=0). In this case, Pc=0 and Pr=1 are recognized in S702 to S705. It is recognized in S706 that the selection range is from a cell (1, 2) to a cell (6, 11). It is further determined in S707 that the pointer variable of the rows is 0<Pr(1)<RowMAX(11) and that the rows are handled as the processing unit.

More specifically, as a result of S702 to S707, the rows other than the rows including items for allowing the person who writes the document to recognize what to write in the fields can be recognized as the processing areas to be checked. Whether all fields corresponding to the items are filled can also be checked row by row.

In S523 of FIG. 3B, whether the processing unit is recognized as the cells as a result of S522 is determined. The process proceeds to S525 if the CPU 11 recognizes that the processing unit is cells, and the process proceeds to S524 in other cases. In S524, unit processing information is generated for the processing unit included in the processing range determined by the CPU 11 in S522.

The processing content determined in S502 includes result output, such as normal (OK)/not normal (NG), and conditions for outputting the results. For example, the condition for outputting the result of normal (OK) is that there is a description, and the condition for outputting the result of not normal (NG) is any cases other than that (“there is a description”). The information generated in S524 includes result output, such as normal (OK)/not normal (NG), not outputting the result (skip), and conditions leading to the results. For example, in the case of the user-designated area 33, the processing content that is determined in S502 and that is for checking whether there is a description is instructed for the processing unit of each row excluding the first row determined in S522. In this case, the CPU 11 sets the fact that all of a plurality of cells included in each row are not filled as a condition for not outputting the result (skip) to generate the unit processing information.

The fact that all cells are filled is set as the condition for outputting the result of normal (OK) to generate the unit processing information. Any other cases are set as the condition for outputting the result of not normal (NG) to generate the unit processing information. In the process of checking the description, the fact that all of the plurality of cells included in each row are not filled denotes that the row is not used. Therefore, the CPU 11 sets the fact that all of the plurality of cells included in the row are not filled as the condition for not outputting the result (skip) to generate the unit processing information. The CPU 11 stores the generated unit processing information in the RAM 18 in association with the positions of the cells included in the rows when the table analysis result of the analysis in S520 is used.

The conditions included in the unit processing information are generated from combination of the processing content determined in S502 and the result of applying the processing content to the cells in the processing unit. Therefore, new complicated information does not have to be generated as the unit processing information.

In S525, the CPU 11 determines whether processing is applied to all user-designated areas. The process proceeds to S526 if the CPU 11 determines that the processing is all finished, and the process returns to S519 if there is a user-designated area not processed yet.

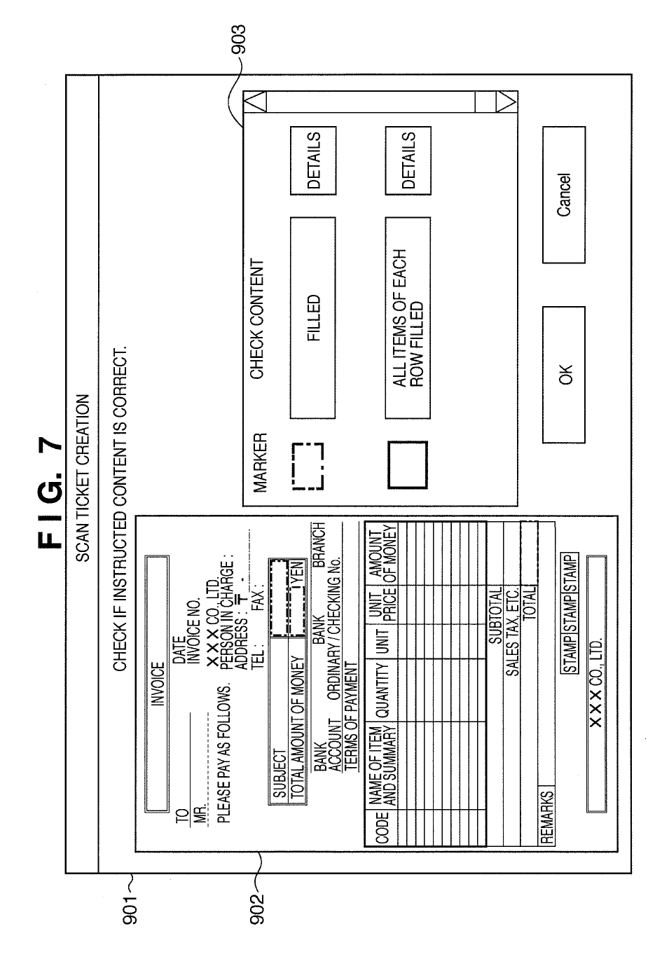

Subsequently, in S526, the CPU 11 displays the information generated based on the result of the analysis and recognition in S518 to S525 on the display unit of the operation unit 16. For example, the areas corresponding to the specified processing instruction information and the processing content for the areas are displayed. A thumbnail image of the read document may be displayed to allow, in association with the image, identifying on which position the processing instruction information exists and identifying the content of processing. FIG. 7 is a diagram showing an example of processing instruction information 901 displayed by the CPU 11 on the display unit of the operation unit 16. The example displays a thumbnail image 902 of the read document, a list 903 of the processing content for the areas, and a button for checking and modifying the detail setting for the processing content.

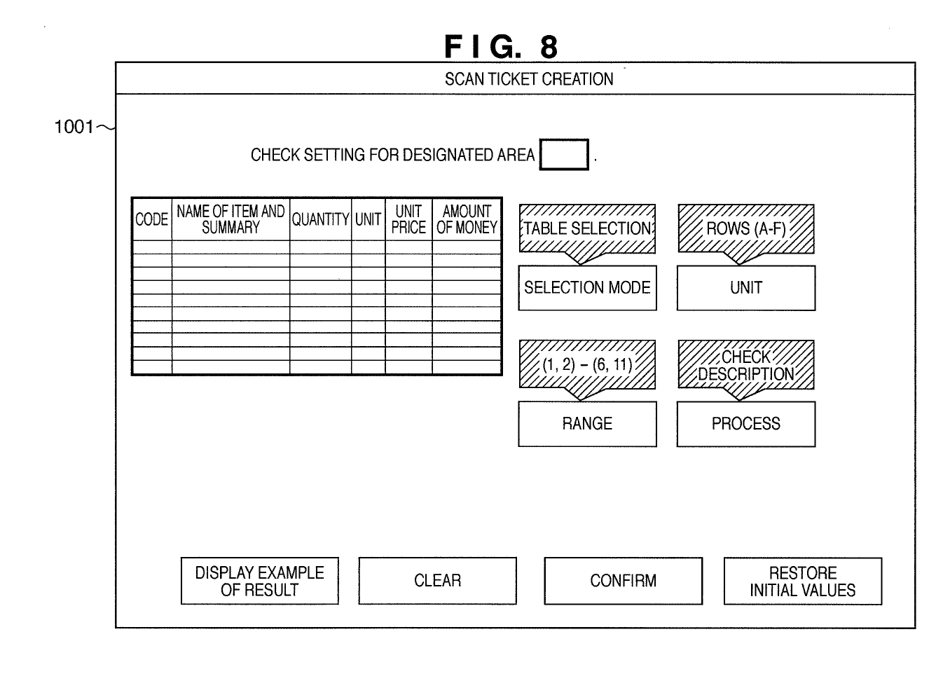

An example of a process when a response for setting the details of the processing content is received from the user through the operation unit 16 will be described with reference to FIGS. 8 to 10. FIG. 8 is a diagram showing an example of a detail setting operation screen of the processing content for the user-designated area 33 shown in FIG. 2B displayed by the CPU 11 on the display unit of the operation unit 16. A screen 1001 includes a selection mode button, a unit button, a range button, and a processing button. The selection mode button is a button for selecting a table or a rectangle. The unit button is a button for displaying a screen for setting the processing unit during a table selection mode. The range button is a button for displaying a screen for setting the selection range. The processing button is a button for setting the processing content. Summaries of the set contents corresponding to the buttons are displayed in popup windows. In this case, “Table Selection”, “Rows (A-F)” for setting the rows as the processing unit, the range “(1, 2)-(6, 11)” where the rows are included, and “Filling Check” as the processing content are set. The screen further includes a button to display an example of the result based on the set content, a button to delete the setting, a button to confirm the setting, and a button to restore the initial values of the setting.

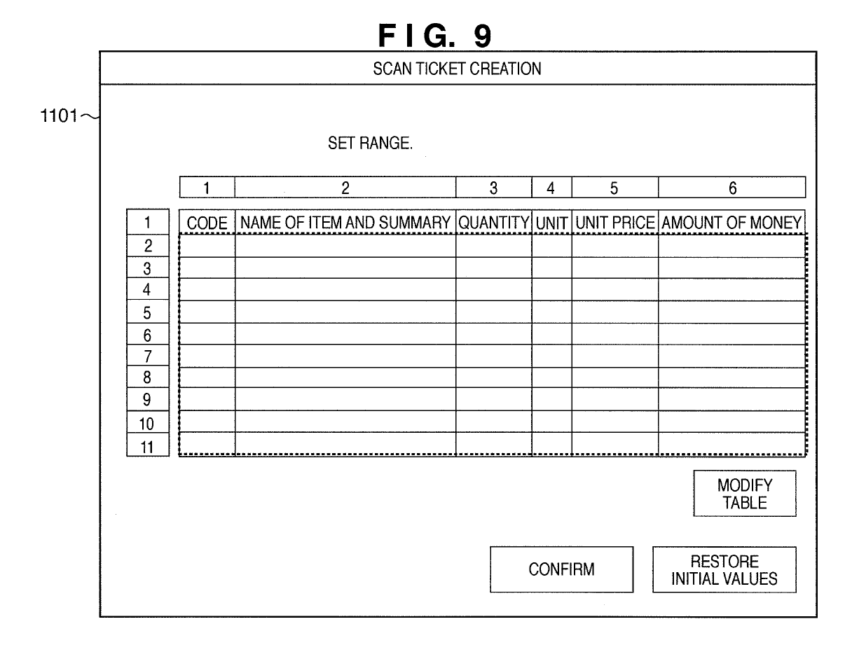

FIG. 9 is a diagram showing an example of a selection range setting screen displayed by the CPU 11 on the operation unit 16 when the CPU 11 receives a response of pressing the range button included in the detail setting operation screen 1001 through the operation unit 16. Based on the result of the analysis and recognition in S518 to S525, if the result of the table analysis by the CPU 11 with the thumbnail image equivalent to the user-designated area 33 in S520 indicates a table (TAB=1), the numbers of the rows/columns and the positions of the cells are associated and displayed. The selection range recognized in S706 is further displayed. The CPU 11 can receive a response for modifying the selection range on a screen 1101 through the operation unit 16.

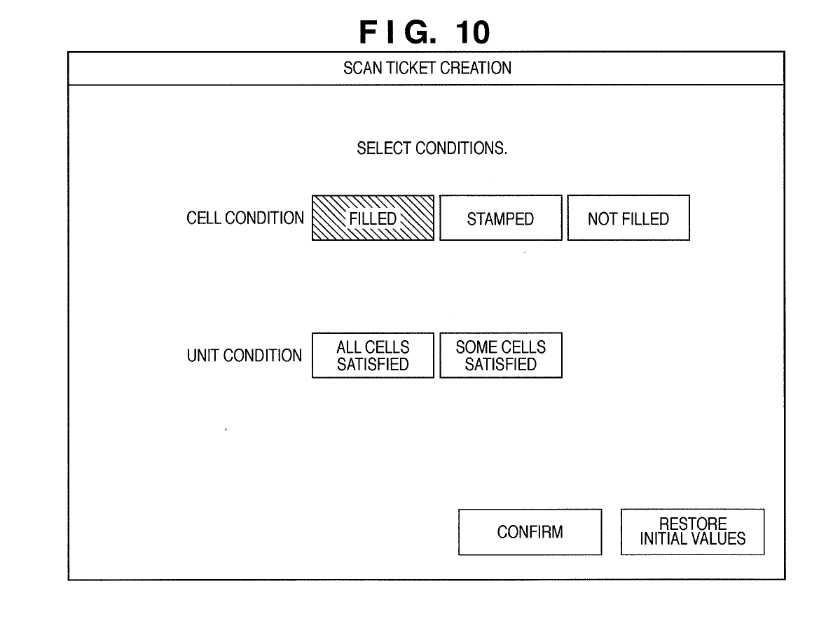

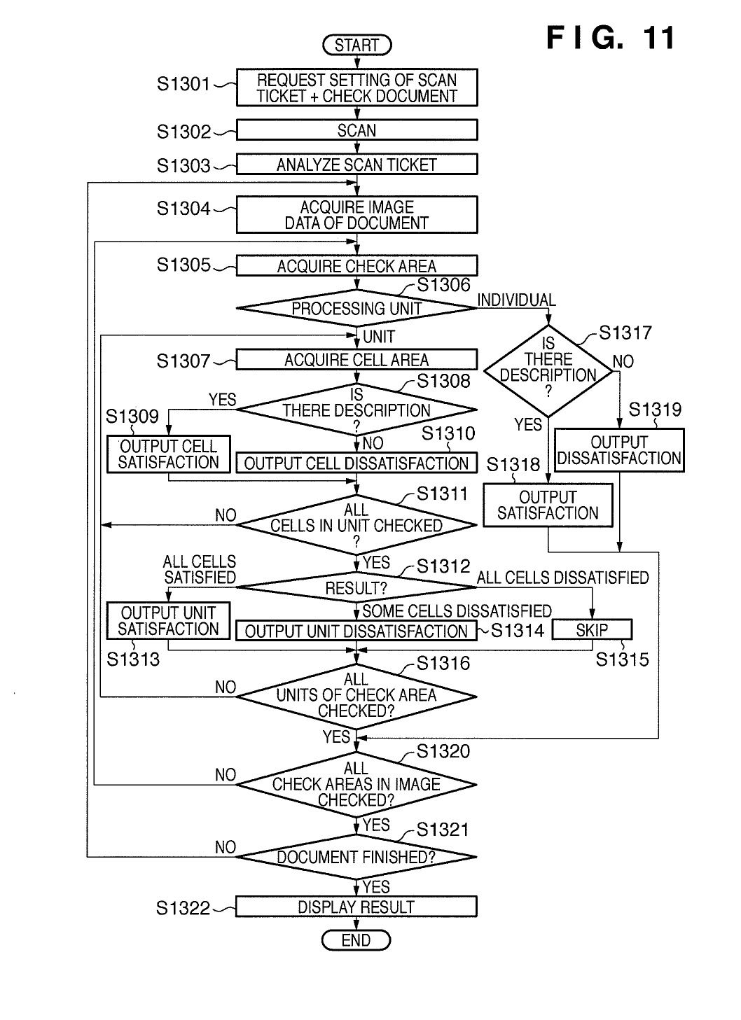

FIG. 10 is a diagram showing an example of a process setting screen displayed by the CPU 11 on the operation unit 16 when the CPU 11 receives a response of pressing the processing button included in the detail setting operation screen 1001 through the operation unit 16. Based on the result of the analysis and recognition in S518 to S525, the CPU 11 displays the processing content for the processing unit on a screen 1201. In this case, the processing unit is rows. A button for setting the cell condition for determining that the plurality of cells included in the rows are normal (OK) and a button for setting the unit condition for determining the result based on combinations of the results of the cells are included. A summary showing what kind of result will be outputted for the unit conditions is also displayed in a popup window.

As described in FIGS. 8 to 10, the CPU 11 can check and modify the processing content and store the content in the RAM 18 by receiving the response for setting the details of the processing content from the user through the operation unit 16.

In S527 of FIG. 3B, the CPU 11 displays a message for the user to check whether the content displayed in S526 is correct on the display unit of the operation unit 16. The process proceeds to S532 if a response of denial by the user for the check is received from the operation unit 16. The CPU 11 displays on the display unit a message for checking whether the template image read by the scanner 15 in S517 will be outputted in black and white by the printer 14.

The process proceeds to S533 if the CPU 11 receives a response of affirmation from the operation unit 16. The image of the document read by the scanner 15 in S517 is converted to monochrome image data, and the printer 14 outputs a monochrome copy.

Therefore, the processing instruction list attached with the processing instruction information is copied in black and white if the processing instruction information is not correctly extracted. The copy is used to add the processing instruction information again. Although the printer 14 prints the document in black and white in S533, the arrangement is not limited to this. The process can be replaced by various methods as in S506.

In S534, the CPU 11 causes the operation unit 16 to show a display to prompt the user to write the processing instruction information on the recording paper outputted by the printer 14 in S533. In S535, if an instruction from the user for indicating not to output the monochrome copy is received from the operation unit 16 in S532, the CPU 11 displays on the display unit a message for checking whether to newly create the processing instruction list. The process proceeds to S536 if an instruction for newly creating the processing instruction list is received from the operation unit 16 in response to the check, and the CPU 11 displays on the display unit a message prompting the user to set the newly created processing instruction list to the scanner. On the other hand, the process ends if an instruction indicating not to newly create the processing instruction list is received from the operation unit 16 in response to the check in S535.

Following the displays of S534 and S536, the process of S517 described above is executed again if the user instructs reading, such as by setting the document and pressing the OK button through the operation unit 16.

If a response indicating that the analysis result is correct is received from the operation unit 16 in S527, the analysis content is stored in the RAM 18 as the result of extraction of the processing instruction information. The process then proceeds to S528, and the CPU 11 displays on the display unit a message for inquiring the user whether to create the scan ticket. The process proceeds to S529 if a response of affirmation is received from the operation unit 16 in response to the display, and the CPU 11 encodes the analysis content.

The encoding of the analysis content denotes encoding of the analysis result displayed in S526 by use of, for example, a two-dimensional code (such as QR code). The content to be encoded includes areas instructed for processing and the processing content for the areas. Although an example of the two-dimensional code will be described, other methods can be used for encoding. The method is not limited to this as long as the image processing apparatus 100 can analyze and recognize the code. In S530, the CPU 11 causes the printer 14 to output and print the encoded content created in S529 on recording paper as an image.

The printed scan ticket can be used to check the document to be checked. However, if the analysis result is determined to be correct in S527, the processing instruction list read by the scanner 15 in S517 is correctly recognized. Therefore, the processing instruction list can be handled as the scan ticket without the execution of the processes of S528 to S530. In that case, the processing content, etc. is recognized from the processing instruction list during the check.

If a response of denial is received from the operation unit 16 in response to the inquiry of S528, the CPU 11 causes the operation unit 16 to display an ID for specifying the analysis content registered in S527. The ID is used for specifying the analysis content and reading the content from the RAM 18 to check the check document. The user may designate a desired ID from the operation unit 16 instead of the CPU 11 presenting the ID. The determined ID and the analysis content are associated and stored in the RAM 18. The process then proceeds to S531.

In S531, the document to be checked is checked in accordance with the recognized processing instruction information and the processing content corresponding to the information.

As a result of the processes, the processing unit can be determined when the table including the item description fields is selected, and the processing instruction for checking whether the content of the processing unit is described can be applied. Not all processes described above have to be executed, and only part of the processes may be executed.

A procedure (S531) of using the created scan ticket to check the document in accordance with the extracted processing instruction information will be described with reference to FIG. 11. In S1301, the CPU 11 displays that the scan ticket will be scanned first and the documents to be checked will be scanned secondly and subsequently on the display unit of the operation unit 16 and prompts the user to set the document.

In S1302, if a sensor not shown detects the setting of the document, the CPU 11 instructs the scanner 15 to read the scan ticket and the document to be scanned and instructs the HDD 13 to store the image data. Although the document to be checked is only FIG. 2C in the first embodiment to simplify the explanation, there may a plurality of documents to be checked.

In S1303, the CPU 11 reads out the image data of the scan ticket stored in the HDD 13 to analyze the scan ticket. In the scan ticket, a plurality of pieces of processing instruction information are encoded to QR codes and printed. Each piece of the processing instruction information includes check area information indicating which area will be checked and a processing code indicating what kind of processing method is used to check the check area. If the processing unit is constituted by a plurality of cells, the processing instruction information includes unit processing information and position information of the cells included in each processing unit.

The CPU 11 detects the positions of the QR codes included in the image data of the scan ticket and decodes the QR codes to acquire a plurality of pieces of processing instruction information. The processing code is a number that indicates what kind of processing method is used to check the check area and that is associated with the processing method for the check area. Only the processing method of checking whether there is a description in the check area is described in the first embodiment, and the details of the processing code will not be described.

If a plurality of documents to be checked are read in S1302, the processing instruction information written in the scan ticket placed first is applied to all second and subsequent documents to be checked. The processing instruction information is effective until the end of the checking process.

In S1304, the CPU 11 sequentially reads out the image data to be checked stored in the HDD 13. In S1305, the CPU 11 selects one of the plurality of pieces of processing instruction information. The CPU 11 uses the start coordinate and the end coordinate indicated by the check area information of the processing instruction information to sequentially acquire the check areas from the image data read out in S1304 and stores the check areas in the RAM 18.

In S1306, the CPU 11 determines whether unit processing information is included in the processing instruction information. The process proceeds to S1307 if the CPU 11 determines that the unit processing information is included, and the process proceeds to S1317 if the CPU 11 determines that the unit processing information is not included.

In S1307, the CPU 11 uses the positions of the cells indicated by the processing instruction information to sequentially acquire the image data of the cell areas in the processing unit from the image data of the check areas acquired in S1305. The positions of the cells are generated in S524 in association with the unit processing information using the table analysis result when the scan ticket is generated. For example, in the case of the area 43, the image data of the cell area acquired first is the first cell of the first row of the designated areas.

The start coordinate (500, 3650) and the end coordinate (400, 150) indicated by the relative coordinate from the start coordinate are used to acquire the image data. The cell acquired next is the second cell in the first row of the designated areas, and the image data is acquired using the start coordinate (900, 3650) and the end coordinate (1500, 150) indicated by the relative coordinate of the start coordinate.

In S1308, the CPU 11 executes a process of checking whether there is a description in the acquired cell area. In this case, the image data in the check area acquired in S1307 is converted to an HLS color space, and whether there is a description in the check area is determined by the proportion of pixels with the luminance L darker than predetermined brightness in the check area. In the first embodiment, the image data of the check area acquired from the image data is an RGB color space. Therefore, the proportion of the pixels with the value of luminance L smaller than 50% in the check area is calculated, and the CPU 11 determines that there is a description in the check area if the portion is 10% or more.

There is no limitation to the determination method as long as whether there is a description can be determined. For example, whether there is a description may be determined based on the length of the dark pixels continuing in the main scanning direction. The conversion from the RGB color space to the HLS color space used here is a known technique, and the details will not be described here.

If the CPU 11 determines that there is a description, the CPU 11 outputs the satisfaction of the normal condition of the cells in S1309. In other cases, the CPU 11 outputs the dissatisfaction of the normal condition of the cells in S1310.

In S1311, the CPU 11 determines whether all cells in the processing unit are checked. The process proceeds to S1312 if all cells are checked. The process proceeds to S1307 if there is an unchecked cell. For example, in the case of the area 43, whether six cells in the column direction in each row are checked is determined.

In S1312, the CPU 11 checks the content of the result of all cells in the processing units checked in S1307 to S1311. If all cells in the processing units are established, e.g. if the row as the first processing unit of the area 43 is filled with “1”, “Red Porgy”, “5”, “Pieces”, “650”, and “3250”, the process proceeds to S1313, and the result that the rows as the processing unit are normal (OK) is outputted. If part of the cells in the processing units is not established, e.g. if there is a cell in part of the row as the third processing unit of the area 43 that does not satisfy the description condition, the process proceeds to S1314, and the result of not normal (NG) is outputted. If all cells in the processing units are not established, e.g. if all cells in the row as the fifth processing unit of the area 43 do not satisfy the description condition, the process proceeds to S1315, and the result is not outputted.

In S1316, the CPU 11 determines whether all processing units in the check areas are checked. The process proceeds to S1320 if all processing units are checked, and the process proceeds to S1307 if there is an unchecked processing unit.

On the other hand, a process of checking whether the check areas acquired in S1305 are filled is executed in S1317. The checking method is the same as in S1308, and the details will not be described here. If the CPU 11 determines that the check areas are filled, the CPU 11 outputs the satisfaction of the normal condition of the check areas in S1318. In other cases, the CPU 11 outputs the dissatisfaction of the normal condition of the check areas in S1319.

In S1320, the CPU 11 determines whether all check areas in the image data of the document are checked. The process returns to S1305 if there are check areas that are not checked, and the checking process of the check areas is sequentially executed. The process proceeds to S1321 if all check areas in the image data of the document are checked.

In S1321, the CPU 11 determines whether processing to all image data of the document to be checked read in S902 is finished, and the process proceeds to S1322 if the processing is finished. The process returns to S1304 if the processing is not finished.

In S1322, when the processing of all check areas for the image data of all documents to be checked is finished, the CPU 11 transmits the check results and an instruction for displaying the check results to the operation unit 16 and ends the checking process. It is obvious that image data may be generated from the check result, and the image data may be transmitted to the printer 14 to output a report, etc.

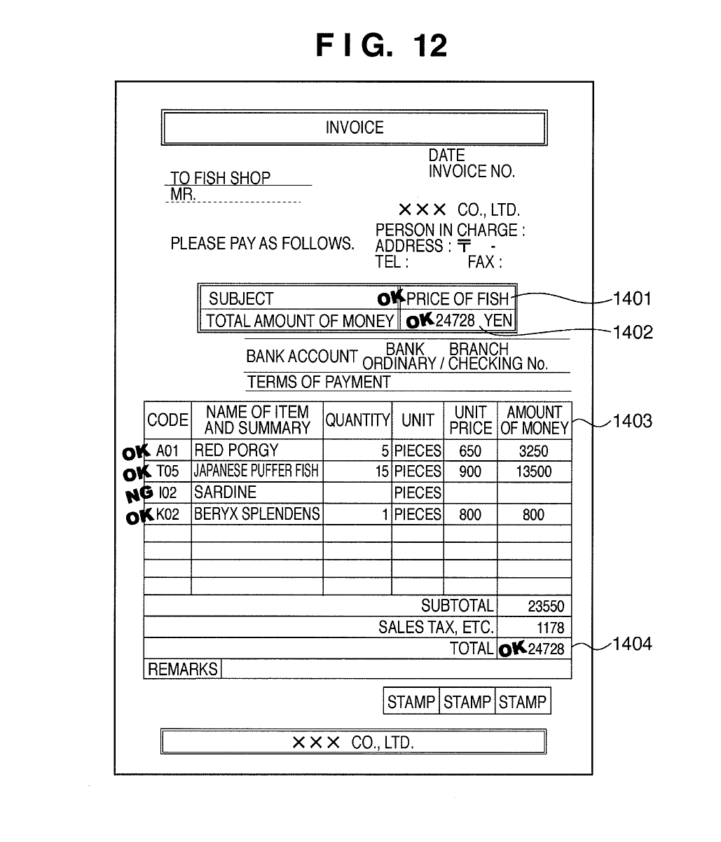

FIG. 12 is a diagram showing an example of outputting the result of checking FIG. 2C to the printer 14. In the example, character strings indicating the results for the check areas are added to the image data obtained in S1304, and the data is printed. The processing units are rows in an area 1403. Therefore, the results corresponding to the results outputted in one of S1313, S1314, and S1315 are added to each row. This can prevent outputting the results for the rows not used at all that are unnecessary for the user.

These are just examples, and only whether the page is OK or NG may be displayed. One NG page may be printed on one recording sheet, or a plurality of NG pages may be reduced to be arranged and printed on the one recording sheet in accordance with the total number of NG pages. The CPU 11 can receive a designation instruction for how to print the NG pages through the operation unit 16 and registers the instruction in advance in the RAM 18.

According to the processes, when the tables are selected by marker along with the item description fields, the processing unit is determined, and the check content for the processing unit is added. As a result, an instruction including more complicated check content can be issued, and the convenience improves.

### Second Embodiment

A second embodiment according to the present invention will be described in detail with reference to the drawings. The configuration of the image processing apparatus in the second embodiment is the same as in the first embodiment, and the description will not be repeated.

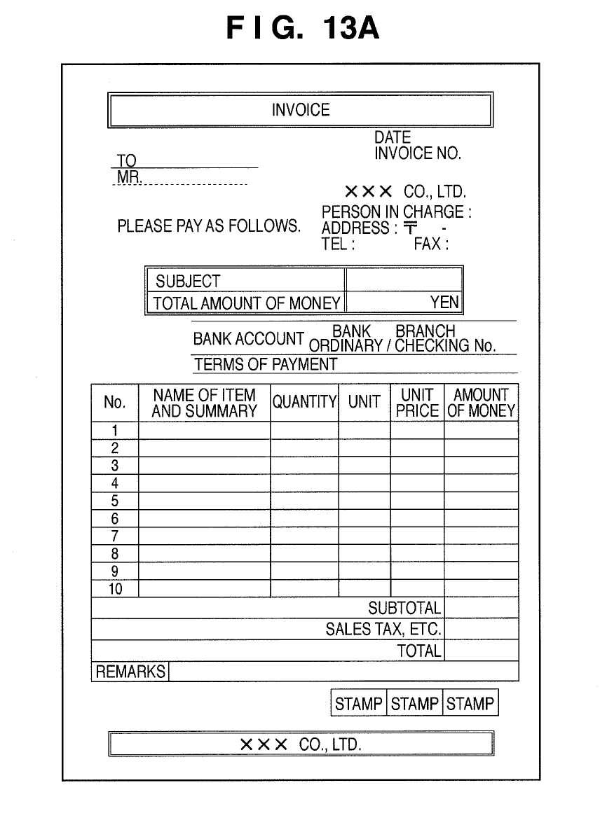

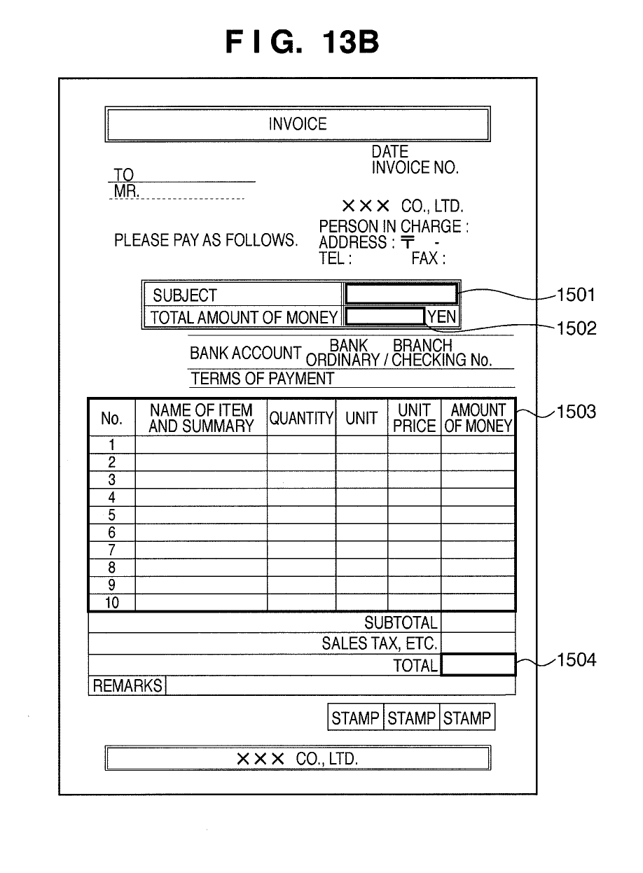

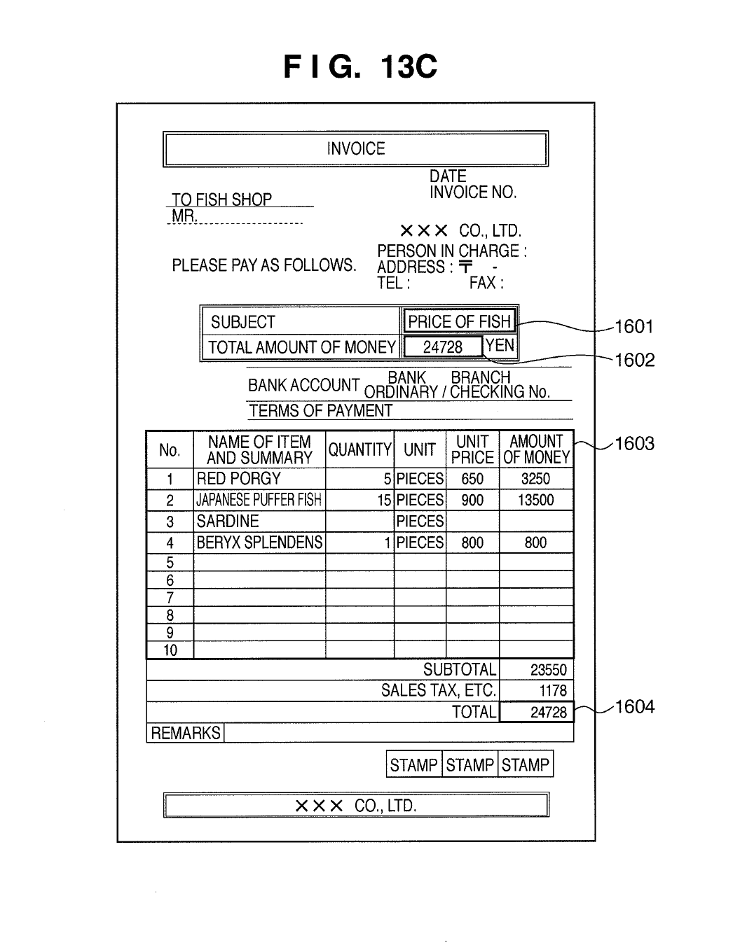

FIG. 13A is a diagram showing an example of a form of a document used in the second embodiment. FIG. 13B is a diagram showing an example of a processing instruction list. FIG. 13C is a diagram showing an example of a document to be checked. The differences from FIGS. 2A, 2B, and 2C used in the first embodiment are that an item of the first column of the table describing the name of item or the amount of money is “No.” instead of “CODE” and that the first row and the first column are filled.

A process of creating a scan ticket used for the check of the written content of the document will be described based on the processing instruction list as shown in FIG. 13B. The scan ticket is the same as that in the first embodiment, and the description will not be repeated. The scan ticket includes the instruction content recognized from the document shown in FIG. 13B, the position information of the areas for applying the instruction content, etc. To check the document to be checked, the scanner 15 reads the scan ticket, and the CPU 11 recognizes the processing content to check the document to be checked.

The scan ticket creation process in the second embodiment is the same as the process in the first embodiment, and the details will not be described. In the second embodiment, when there are filled fields in both rows/columns of the table and there is regularity in the written content in one of the rows/columns, a process of determining the processing unit based on the regularity of the written content is set in the processing unit determination process (S522).

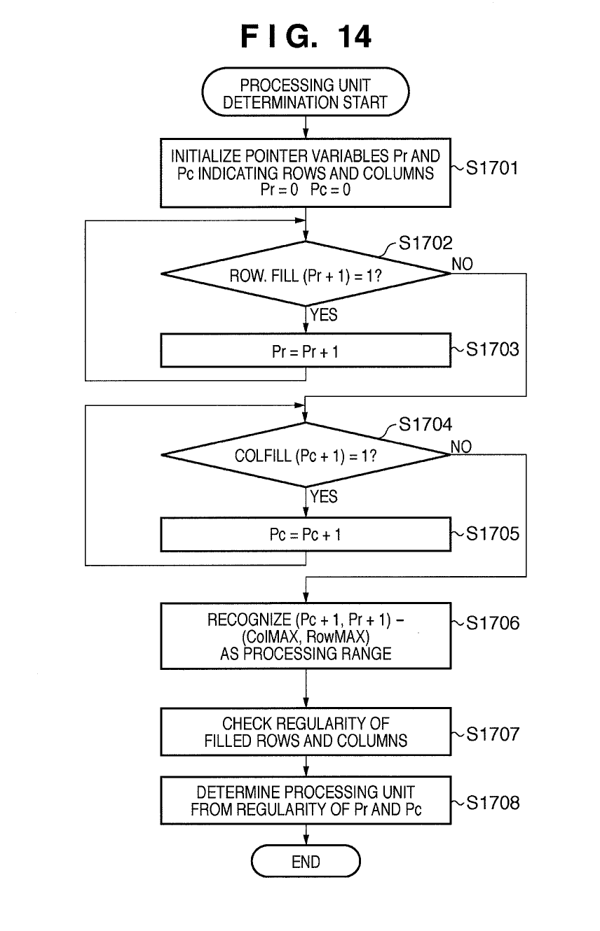

FIG. 14 is a flow chart showing a processing unit determination process in the second embodiment. S1701 to S1706 are the same as S701 to S706 shown in FIG. 5, and the CPU 11 recognizes the processing range to be checked and the rows/columns in which all fields are filled.

In S1707, the CPU 11 checks the regularity in the filled rows/columns adjacent to the processing range recognized in S1701 to S1706. More specifically, the written content is checked in the rows in which all fields are filled, i.e. in a range from a cell (Pc+1, Pr)=(2, 1) to a cell (ColMAX, Pr)=(6, 1). The written content is also checked in the columns, i.e. in a range from (Pc, Pr+1)=(1, 2) to a cell (Pc, RowMAX)=(1, 11).

The CPU 11 executes an OCR process to analyze whether character information is included in the cells in the row/column range in the table analyzed in S520. As a result of the OCR process, “Name of Item and Summary”, “Quantity”, “Unit”, “Unit Price”, and “Amount of Money” are sequentially recognized as the character information in the range of the rows. In the range of the columns, “1”, “2”, “3”, “4”, “5”, “6”, “7”, “8”, “9”, and “10” are sequentially recognized. The CPU 11 further executes a matching process of the recognized character information and consecutive data patterns and checks whether there is regularity in the recognized character information. The consecutive data patterns denote consecutive numbers such as “N” and “N+m” (N and m are natural numbers), alphabetical order such as “A” and “B”, etc. In the second embodiment, the CPU 11 recognizes the regularity in the range of the columns.

In S1708, the regularity recognized in S1707 is used to determine the processing unit. The CPU 11 recognizes that the processing unit is cells if both rows/columns do not have regularity or both rows/columns have regularity. The CPU 11 recognizes that the processing unit is columns if only rows have regularity and recognizes that the processing unit is columns if only columns have regularity as in the second embodiment.

The procedure (S531) of using the scan ticket created in the processes to check the document according to the extracted processing instruction information is the same as in the first embodiment, and the details will not be described.

According to the second embodiment, in addition to the advantage of the first embodiment, the processing unit constituted by a plurality of cells can be determined when the written content of one of rows/columns in the user-designated area has regularity. Therefore, the convenience of the user improves.

### Third Embodiment

A third embodiment of the present invention will be described in detail with reference to the drawings. A configuration of the image processing apparatus in the third embodiment is the same as in the first embodiment, and the description will not be repeated.

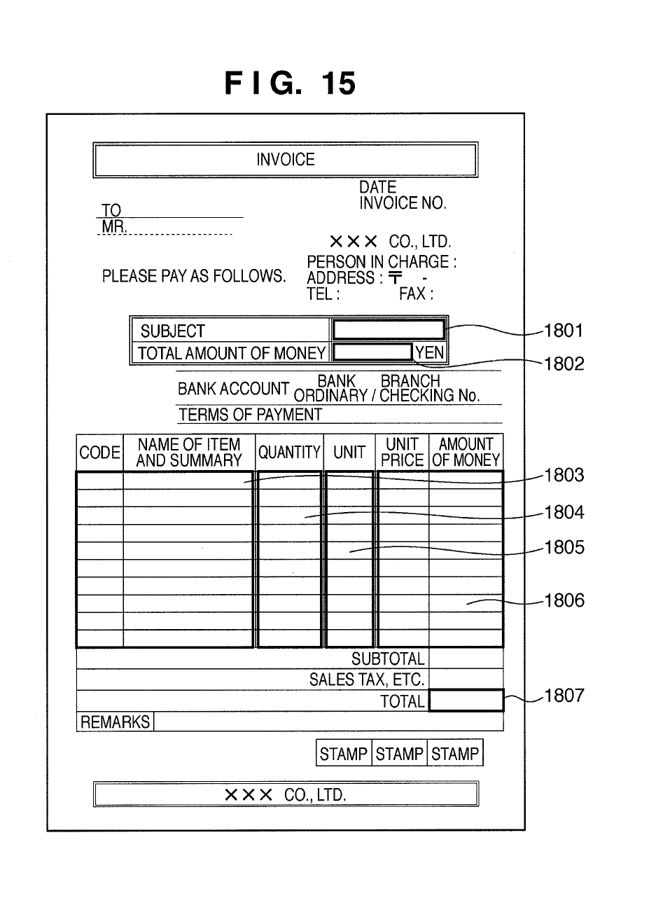

FIG. 15 is a diagram showing an example of a processing instruction list used in the third embodiment. An example of the form of the document and an example of the document to be checked are the same as in FIGS. 2A and 2C, respectively, and the description will not be repeated. The point that the processing instruction list in the third embodiment is different from FIG. 2B is a method of the user using a color pen to add an instruction to the table.

The processing instruction information (additional information) written in the invoice (document) will be described. In FIG. 15, for example, areas 1801 to 1803, an area 1805, and an area 1807 are areas written by a red pen, and an area 1804 and an area 1806 are areas written by a blue pen.

The user associates the information of the color of the processing instruction information to be used with the processing content in advance and uses the operation unit 16 to register the information and the content in the RAM 18. More specifically, checking of the description of information is registered in the RAM 18 for the red color, and checking of the description of numbers is registered in the RAM 18 for the blue color. The CPU 11 determines the color components (such as hue) of the registered colors and stores the content in the RAM 18.

Instead of using the operation unit 16 to register the colors, the scanner 15 may read the writing on the paper to register the colors. Instead of the user registering the colors, the colors may be registered in the image processing apparatus 100 in advance. The user adds the processing instruction information to the document in accordance with the registered colors and processing content when the content registered in advance is followed.

In this way, the color components of the processing instruction information to be used and the processing content corresponding to the color components are registered to create a processing instruction list according to the color components and the processing content. The processing instruction information is extracted from the processing instruction list, and the processing content is recognized according to the extraction result to check whether there is information in specific areas of the document to be checked.

A process of creating a scan ticket for checking the written content of the document will be described based on the processing instruction list as shown in FIG. 15. The scan ticket is the same as in the first embodiment, and the description will not be repeated. The scan ticket includes instruction content recognized from the document shown in FIG. 15, position information of the areas for applying the instruction content, etc. To check the document to be checked, the scanner 15 reads the scan ticket, and the CPU 11 recognizes the processing content to check the document to be checked.

The scan ticket creation process in the third embodiment is the same as the process of the first embodiment, and the details will not be described. In the third embodiment, a process, which is for handling a plurality of user instructed areas as one processing area if there are user instructed areas with the same height or the same width on the table in the document, is set in the instruction content analysis process (S518). A process of generating unit processing information corresponding to the plurality of user instructed areas is also set in the unit processing information generation process (S524).

In the first embodiment, the CPU 11 specifies the positions of the areas of each instructed color from the image data inputted from the scanner 15. In the third embodiment, the CPU 11 further executes a process of analyzing the positional relationship between the user-designated areas and a process of generating new designated areas including a plurality of instruction areas.

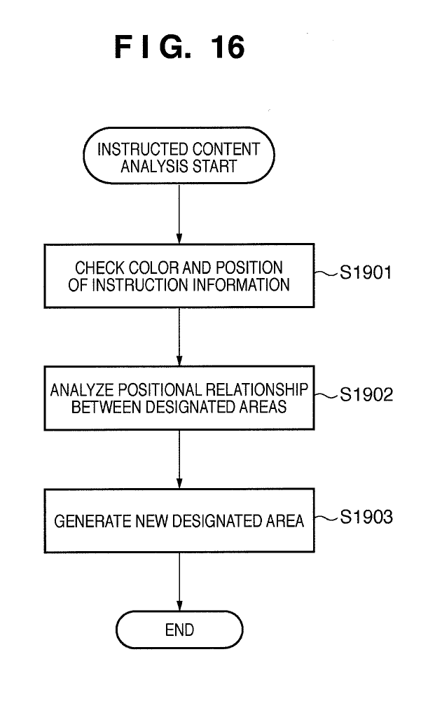

FIG. 16 is a flow chart showing an instruction content analysis process in the third embodiment. In S1901, the instructed colors and the positions of the user-designated areas, i.e. closed areas written by the user with pens, are recognized as in the first embodiment. In S1902, the positional relationship between the user-designated areas is analyzed. In the process of analyzing the positional relationship between the user-designated areas, whether some of the areas indicated by the start coordinate and the end coordinate of the user-designated areas are related is analyzed. Whether the areas are related is analyzed by checking the coordinates. For example, in the case of the processing instruction list shown in FIG. 15, the areas 1803 to 1806 are in a positional relationship in which the start coordinate and the end coordinate in the sub scan direction is within ±25, and the positional relationship between the areas is within ±25. Therefore, the fact that the designated areas are horizontally aligned in the same sub scan width is confirmed.

Although the positional relationship between the areas is checked based on whether the coordinates are within a predetermined value, the positional relationship may be checked based on whether the coordinates are within a value that can be arbitrarily set, or the value may be changed depending on the sizes of the areas.

In S1903, a new designated area is generated. Specifically, vertically aligned designated areas in the same main scan width or horizontally aligned designated areas in the same sub scan width are generated as one designated area in the process of analyzing the positional relationship between the user-designated areas. The CPU 11 associates the position information of the plurality of user-designated areas and the processing method determined in S502 and stores the information and the method in the RAM 18.

In the first embodiment, the processing unit is determined based on the positions of the filled cells in the table in S522. However, in the third embodiment, the columns are determined as the processing unit if the newly generated designated area is formed by a plurality of vertically aligned designated areas, and the rows are determined as the processing unit if the newly generated designated areas are formed by a plurality of horizontally aligned designated areas in S518.

In the unit processing information generation process (S524), information including conditions for outputting the results of normal (OK)/not normal (NG) and not outputting the result (skip) is generated. As for the designated area newly generated by the CPU 11 from the areas 1803 to 1806, the condition for normal (OK) is “filled”, and the condition for not normal (NG) is any case other than normal (OK) in the area equivalent to the areas 1803 and 1805. The condition for normal (OK) is “number is written”, and the condition for not normal (NG) is any case other than normal (OK) in the area equivalent to the areas 1804 and 1806. In this case, the CPU 11 sets the fact that all of a plurality of cells included in each row are not filled as a condition for not outputting the result (skip) to generate the unit processing information.

More specifically, in relation to the satisfaction conditions applied to the cells, if the CPU 11 can recognize requirements for a situation in which the cells are not used as fields in the table, the CPU 11 generates a condition of not outputting the result (skip) based on combinations of the satisfaction conditions applied to the cells. The CPU 11 sets the fact that “there is a description” in the area equivalent to the areas 1803 and 1805 and that “number is written” in the area equivalent to the areas 1804 and 1806 as the condition for outputting the result of normal (OK) to generate the unit processing information. The CPU 11 further sets any other cases as the condition for outputting the result of not normal (NG) to generate the unit processing information. As opposed to the process of checking whether “there is a description” and “number is written”, the fact that all of the plurality of cells included in each row are not filled indicates that the row is not used. Therefore, the CPU 11 sets the fact that all of the plurality of cells included in each row are not filled as the condition for not outputting the result (skip) to generate the unit processing information.

When the new designated area generated in S518 is used, the CPU 11 stores the generated unit processing information in the RAM 18 in association with the positions of the cells included in the rows. Although the fact that there is a description and that the number is written is set as the condition for executing the checking process, other conditions, such as there is no description or there is a red description, may be used.

The procedure (S531) of using the scan ticket created in the processes to check the document according to the extracted processing instruction information is the same as in the first embodiment, and the details will not be described. Although only whether there is a description is determined in S1308 and S1317, the CPU 11 executes a determination process according to the processing contents if there are a plurality of processing contents determined in S502.

According to the third embodiment, in addition to the advantage of the first embodiment, an instruction for checking based on combinations of a plurality of check contents is possible when an instruction for checking the processing unit formed by a plurality of cells in the table is issued. Therefore, the convenience of the user improves.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-021587, filed Feb. 2, 2010, which is hereby incorporated by reference herein in its entirety.

What is claimed is:

1. An image processing apparatus that generates processing instruction information for instructing a process for a specific area of a document, the apparatus comprising:
a determination unit that analyzes a table structure in the specific area of the document to determine a plurality of cells included in a table as a processing unit; and
a generation unit that generates the processing instruction information for instructing a process for the processing unit determined by said determination unit.

2. The apparatus according to claim 1, wherein
said determination unit determines one of cells, rows, and columns as the processing unit depending on whether cells in the table indicated by a predetermined color are filled and depending on the number of cells in the table.

3. The apparatus according to claim 2, wherein
said determination unit determines one of cells, rows, and columns as the processing unit depending on whether the content has regularity when all rows or columns in the table indicated by a predetermined color are filled.

4. The apparatus according to claim 2, wherein
said determination unit determines one of cells, rows, and columns as the processing unit depending on whether the content has regularity when all rows or columns in the table indicated by a predetermined color are filled.

5. The apparatus according to claim 1, wherein
said generation unit generates the processing instruction information for instructing a process of determining whether all of a plurality of cells included in the processing unit are filled or whether all of the plurality of cells included in the processing unit are not filled.

6. The apparatus according to claim 3, wherein
the content with the regularity is consecutive numbers or characters in alphabetical order.

7. The apparatus according to claim 1, wherein
said determination unit determines the processing unit based on a positional relationship between cells in the table indicated by a predetermined color.

8. A processing method of an image processing apparatus that generates processing instruction information for instructing a process for a specific area of a document, the method comprising:
determining a plurality of cells included in a table as a processing unit by analyzing a table structure in the specific area of the document; and
generating the processing instruction information for instructing a process for the processing unit determined in said determining.

9. A computer-readable recording medium recording a program causing a computer to execute the processing method of the image processing apparatus according to claim 8.

10. An image processing apparatus that comprises a reading unit that reads a document and that recognizes information added by handwriting in a document read by said reading unit, the apparatus comprising:
a recognition unit that recognizes areas of the information added by handwriting and a process associated with a color of the information added by handwriting;
a table analysis unit that analyzes a table included in the read document using the added information;
a processing unit determination unit that determines a plurality of cells included in the table as a processing unit using a result analyzed by said table analysis unit; and
a unit processing information generation unit that generates processing information for the processing unit determined by said processing unit determination unit using the added information.

11. The image processing apparatus according to claim 10, wherein
said table analysis unit comprises a unit that recognizes whether cells included in the analyzed table are filled, and said processing unit determination unit uses a combination of positions of the filled cells recognized by said table analysis unit to determine the processing unit.

12. The image processing apparatus according to claim 10, wherein
the processing content recognized by said recognition unit includes output of results and satisfaction conditions for outputting the results, and
said unit processing information generation unit generates the output of the results for the processing unit and the satisfaction conditions for outputting the results as unit processing information, and the satisfaction conditions are formed by combinations of the satisfaction conditions of the processing content for the cells included in the processing unit determined by said processing unit determination unit.

13. The image processing apparatus according to claim 10, said processing unit determination unit further comprising:
a written content recognition unit that recognizes the written content of the cells analyzed by said table analysis unit; and a regularity checking unit that checks whether the written content recognized by said written content recognition unit has regularity, wherein
the regularity checked by said regularity checking unit is used to determine the processing unit.

14. The image processing apparatus according to claim 13, wherein
the regularity checked by said regularity checking unit is consecutive numbers or characters in alphabetical order.

15. The image processing apparatus according to claim 10, said recognition unit further comprising
a unit that uses positions of the areas of the recognized additional information to generate another processing area including a plurality of areas of the additional information, wherein
said processing unit determination unit further uses the positions of the plurality of areas of the additional information included in the processing areas generated by said recognition unit to determine the processing unit.

16. An image processing method of an image processing apparatus that comprises a reading step for reading a document and that recognizes information added by handwriting in a document read in said reading step, the method comprising:
a recognition step of recognizing areas of the information added by handwriting and a process associated with a color of the information added by handwriting;
a table analysis step of analyzing a table included in the read document using the added information;
a processing unit determination step of determining a plurality of cells included in the table as a processing unit using a result analyzed in said table analysis step; and
a unit processing information generation step of generating processing information for the processing unit determined in said processing unit determination step using the added information.

17. A computer-readable recording medium recording a program causing a computer to execute the processing method of the image processing apparatus according to claim 16.
